(19) United States
(12) Patent Application Publication
(10) Pub. No.: US 2013/0038099 A1
(43) Pub. Date: Feb. 14, 2013

(54) Blast Mitigating, Fully Adjustable, Turret Seating System

(71) Applicants: Shy Mindel, Holon (IL); Anan Hasan, Julis (IL); Matthew C. Gross, Mohnton, PA (US); Matthew Shehoski, Gilbertville, PA (US); John-Paul McGovern, Chester Springs, PA (US)

(72) Inventors: Shy Mindel, Holon (IL); Anan Hasan, Julis (IL); Matthew C. Gross, Mohnton, PA (US); Matthew Shehoski, Gilbertville, PA (US); John-Paul McGovern, Chester Springs, PA (US)

(73) Assignee: Global Seating Systems, LLC, Exton, PA (US)

(21) Appl. No.: 13/566,114

(22) Filed: Aug. 3, 2012

Related U.S. Application Data
(60) Provisional application No. 61/522,359, filed on Aug. 11, 2011.

(51) Int. Cl. B60N 2/42; B60N 2/02

(52) U.S. Cl. 297/216.1

(57) ABSTRACT

A fully adjustable seat assembly adapted for a motor vehicle with safety features including a blast mitigating device, such as an energy attenuation device, to absorb energy in a controlled manner. Another safety features is a one-hand lap belt release system. The seat assembly preferably has a back cushion support with a seat base that automatically flips-up when not in use. When used in a vehicle turret, the seat assembly can provide for 360 degrees of rotational movement with a bracket and a single bearing.

### CROSS REFERENCE TO RELATED APPLICATION

This application claims priority from provisional application 61/522,359, filed Aug. 11, 2011, which is incorporated herein by reference.

### FIELD OF THE DISCLOSURE

This disclosure relates to a seating system for motor vehicles, such as used by the military. More specifically, the seating system includes a blast-mitigating device while still being fully adjustable.

### BACKGROUND

Seats used in some motor vehicles, especially seats used in military vehicles, have to be able to account for severe and sudden movements and shock, such as those that occur during a blast situation—an explosion from a mine or TED. Various blast-mitigating devices have been designed to withstand the intense shock transferred to the interior of the vehicle as a result of an exploding mine, such as a blast box that collapses under the vertical impact of an IED, a mine, or other explosive device. The collapse is controlled in that it absorbs a certain amount of energy and thereby helps to protect the occupant of the vehicle.

U.S. Publication 20100156153 discloses a seat assembly having a front and a back and adapted to be attached to a floor and comprises a seat base and a seat back attached to the seat base, a seat belt mechanism attached to the seat base and free of the floor, a blast-mitigation device attached to the seat base and adapted to be secured to the floor, wherein the blast-mitigation device has a crumple zone that absorbs energy in the event of a blast, and a front impact dislocation resistance device mounted on the blast-mitigation device with a pair of brackets. The front impact dislocation resistance device acts to resist separation of the seat base from the blast-mitigation device.

### SUMMARY

The present disclosure provides a seat assembly with a range of comfort features including full height adjustment for a 5^{th} percentile female to a 95^{th} percentile male, back cushion support with a flip-up seat cushion, and 360 degrees of rotational movement. The seat height fully adjusts using a hardened shaft, ball bearing and gas shock on both sides of the system.

A preferred blast-mitigating, fully adjustable, turret seating assembly may include a seat with a seat back and a seat base cushion that automatically flips up. A preferred vertical movement device for height adjustment may have linear guides cooperating with roller bearings on each side adjacent to the seat back to provide smooth vertical motion. A height adjustment lock with a cam-action locking detent can secure the seat at different heights. A bottom seat bracket with a preferred single bearing at a base of the seating assembly can secure the seating assembly to a floor of the vehicle, and a seat mount at a top portion of the seating assembly can secure the seating assembly to a turret of the vehicle to both allow the seat to freely rotate relative to the turret. An energy attenuation device on a side of the seating assembly is preferably aligned with the linear guides.

The seating system provides safety with a blast-mitigating device. A linear guide with two roller bearings on either side of the system can cooperatively provide smooth vertical motion. An energy attenuation (EA) device on either side can move during a blast event to absorb the energy in a controlled manner.

The seating system also provides safety with a one-hand lap belt release system. In a preferred restraint system, lap belts can release using cables and a single actuator located at the center of the seat pan.

The seat assembly may include an automatic base cushion flip-up feature. A gas shock or a torsion spring on either side or both sides of the seat back can hold the seat in the flipped-up position when not in use.

If used in a turret, the seat assembly can provide for full rotational movement. The seat bolts to the turret at the top and rotates freely using a single bearing mounted at the bottom to the vehicle floor.

### BRIEF DESCRIPTION OF THE DRAWINGS

The above-mentioned and other features of this disclosure and the manner of obtaining them will become more apparent, and the disclosure itself will be best understood by reference to the following descriptions of devices taken in conjunction with the accompanying figures, which are given as non-limiting examples only, in which:

FIG. 1 shows a perspective view of a seat assembly with a seat down;

FIG. 2 shows a perspective view of the seat assembly with the seat flipped up;

FIG. 3 shows another view of the seat assembly;

FIG. 4 shows a side view of a seat assembly of FIG. 3;

FIG. 5 shows a perspective view of a seat assembly with the pans revealed and cushions, foam and upholstery not shown for clarity;

FIG. 6 shows a front view of the seat assembly of FIGS. 1 and 2;

FIG. 7 shows a view of a height adjustment lock with the cam-action locking detent in the locked position;

FIG. 8 shows a view of the cam-action locking detent in the unlocked position;

FIG. 9 shows a back view of the seat assembly with an automatic flip-up feature for a seat base;

FIG. 10 shows a perspective front view of the seat assembly;

FIG. 11 shows a perspective view of the rear of the seat assembly with the seat down; and

FIG. 12 show a perspective view of the front of the seat assembly with the seat down with a linear guide with roller bearings.

The exemplifications set out herein illustrate embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiments in different forms, the figures show, and herein described in detail, embodiments with the understanding that the present descriptions are to be considered exemplifications of the principles of the disclosure and are not intended to be exhaustive or to limit the disclosure to the details of construction and the arrangements of components set forth in the following description or illustrated in the figures.

As shown in the Figures, a seat assembly 20 includes a seat back 22 with a seat base 24 that preferably flips-up in a frame 26 used in conjunction with a height adjustment system 28, a blast-mitigating device 30, and a lap belt release system 32.

The seat back 22 may include a back pan 34 and a back cushion 36, and the seat base 24 may include a seat pan 38 and a seat cushion 40. The seat base 24 can be pivotal on a frame base 41 that can adjust within a frame 26 with two side portions 42 and 44, a top portion 46 and a bottom portion 48.

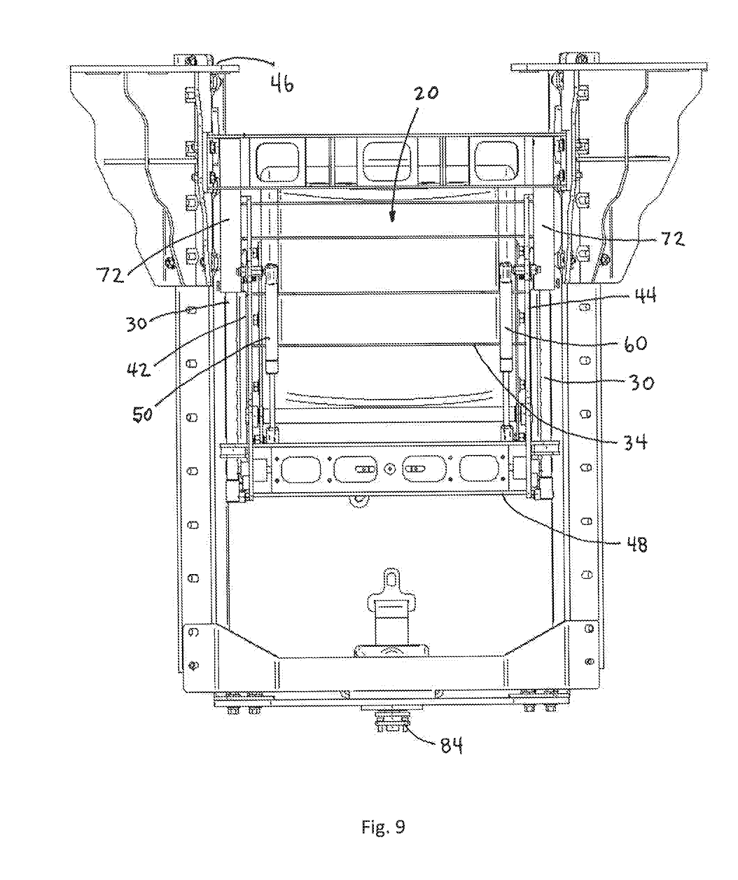

The seat assembly 20 may include an automatic cushion base flip-up feature, including a gas shock 50, a spring or an equivalent. As shown in FIG. 9, a gas shock 50 and 60 adjacent to either side portion 42 or 44 of the seat back pan 34 can hold the seat base 24 in the flipped-up position when not in use. The gas shock 50 or 60 raises the seat automatically when the lock is disengaged and/or the seat base 24 is unoccupied.

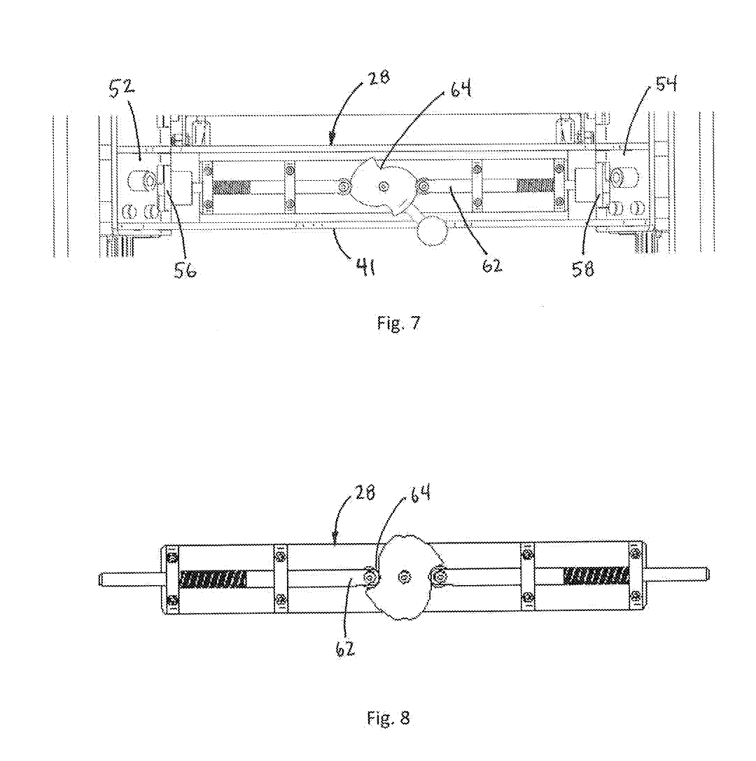

The height adjustment system 28, as shown in FIGS. 7 and 8, can allow the height of the seat base 24 to be fully adjustable using a hardened shaft 52 and 54, a ball race 56 and 58 with ball bearings and a gas shock 50 and 60 on each side portion 42 and 44.

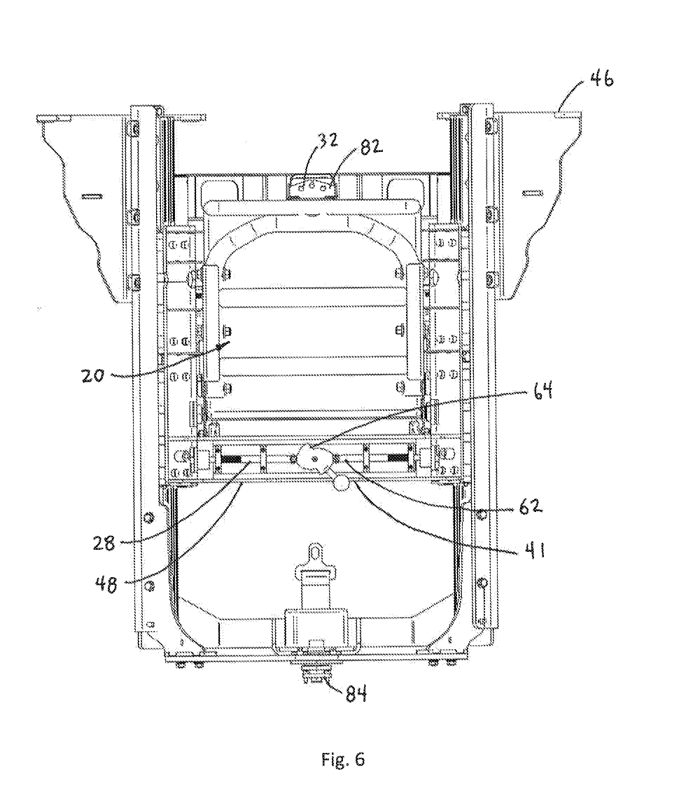

As shown in FIGS. 6-8, a height adjustment lock 62 can include a cam-action locking detent 64 to secure seat base 24 at different height levels. It is shown as mounted on the frame base 41. The height adjustment lock 62 is shown in FIGS. 6 and 7 as locked, and in FIG. 8, the lock 62 is in an unlocked position.

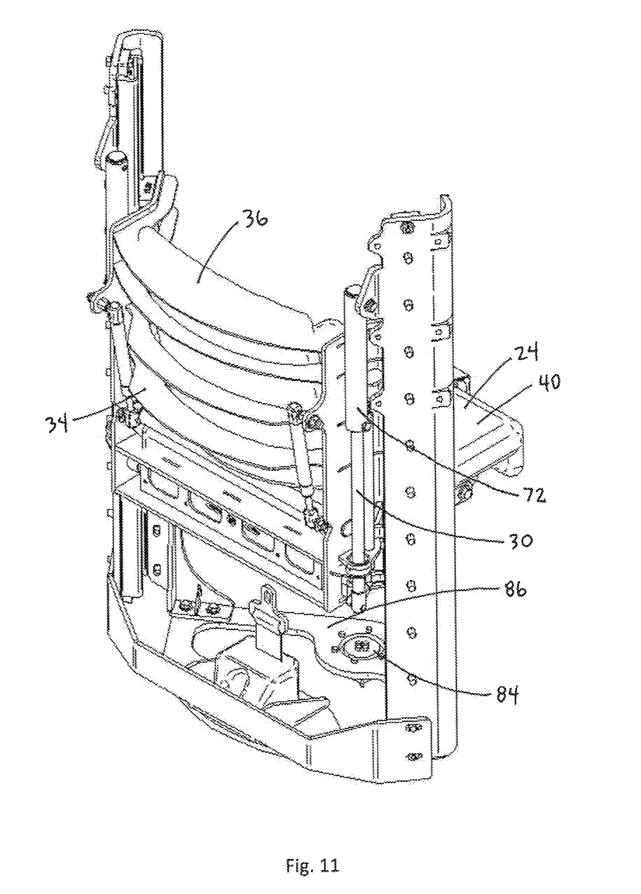

As shown in FIG. 11, the blast-mitigating device 30 provides safety in a blast event. A vertical movement device may include linear guides 66 adjacent to two roller bearings 68 and 70 on either side of the system to provide smooth vertical motion. The roller bearings 68 and 70 can be secured to the seat back 22. An energy attenuation (EA) device 72 on either side or both sides can elongate or otherwise move during a blast event to absorb the energy in a controlled manner. A coiled portion may be an arrangement of somewhat rigid material in a spiral that linearly elongates under extreme pressure to absorb energy. The blast-mitigating device 30 can also be a linear actuator. The blast-mitigating device 30 can be aligned with a linear guide 66 or preferably both, which allows the seat assembly 20 to stroke vertically to reduce the forces experienced by the occupant in the event of a blast.

The lap belt release system 32 can also provide safety with a one-hand lap belt release system. In a preferred restraint system, lap belts can release using cables 78 and 80 (which may be internal to the seat cushion 40) and a single actuator 82, such as a button, located at the front center of the seat pan 38. The lap belt release system 32 is preferably connected to the frame base 41 to adjust with the seat base 24.

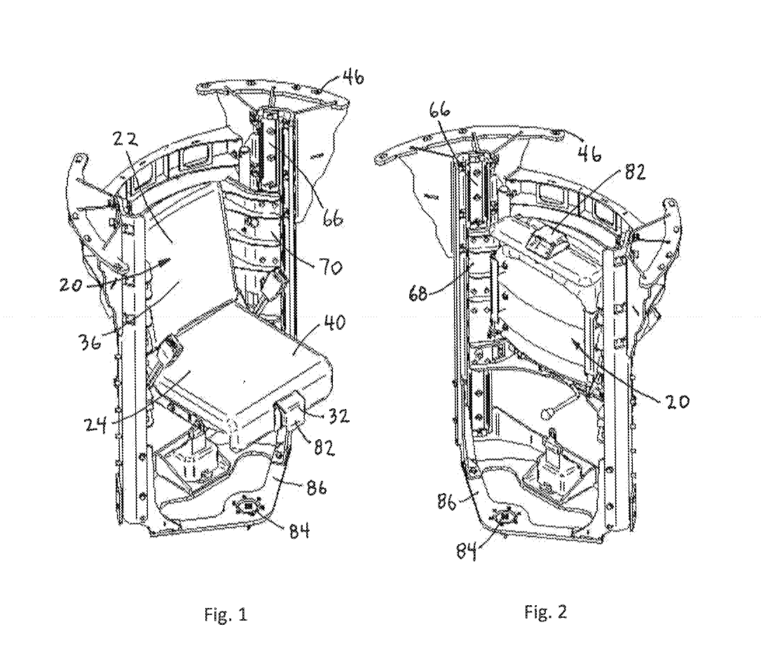

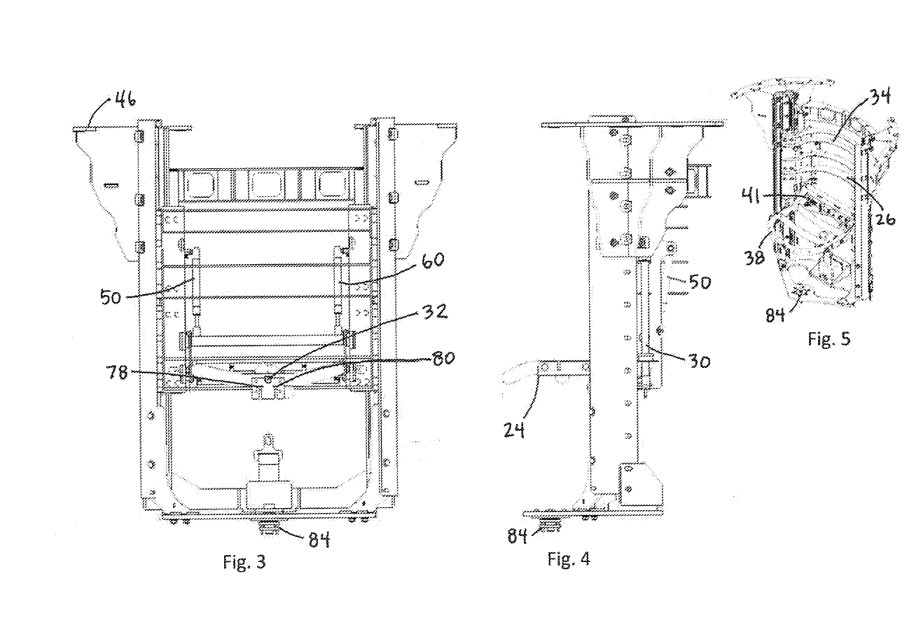

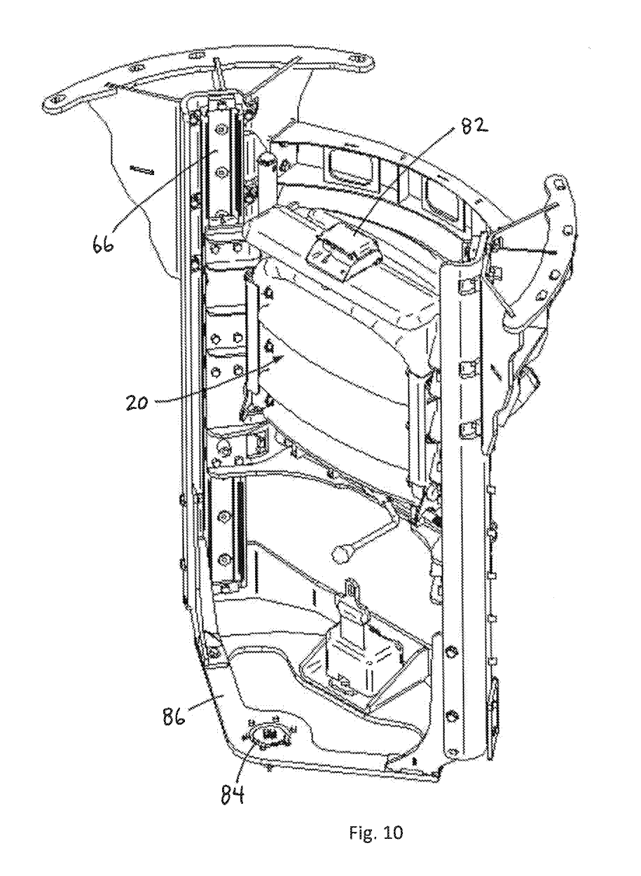

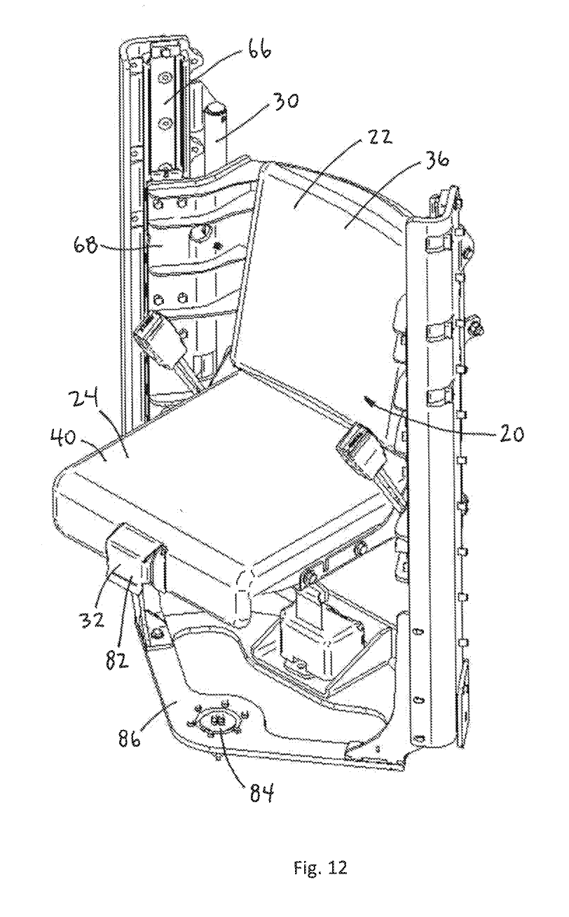

Rotational movement of 360 degrees is preferred if used in a turret of a vehicle. The seat assembly 20 can mount, such as being bolted, to a turret at the top portion 46 of the seat assembly 20 and then rotate freely using a bearing 84 with a bottom seat bracket 86 mounted below the bottom portion 48 attached to the vehicle floor. An example bottom seat bracket 86 with a bearing 84 as shown in FIGS. 1-6 and 9-12 allows the seat assembly 20 to rotate freely. The bottom seat bracket 86 with the bearing 84 at a base of the assembly 20 can mount to a vehicle floor. The bottom seat bracket 86 preferably has a single bearing 84 as shown at a base of the seat assembly 20. The bearing 84 also ensures compliance with FMVSS testing.

This disclosure has been described as having exemplary embodiments and is intended to cover any variations, uses, or adaptations using its general principles. It is envisioned that those skilled in the art may devise various modifications and equivalents without departing from the spirit and scope of the disclosure as recited in the following claims. Further, this disclosure is intended to cover such variations from the present disclosure as come within the known or customary practice within the art to which it pertains.

What is claimed is:

1. A blast-mitigating, adjustable seating assembly for a vehicle with a turret comprising:
a seat with a seat back and a seat base that automatically flips up;
a vertical movement device with linear guides cooperating with roller bearings on each side adjacent to the seat back to provide smooth vertical motion;
a height adjustment lock;
a bottom seat bracket with a bearing at a base of the seating assembly to secure the seating assembly to a floor of the vehicle;
a top portion of the seating assembly mounted onto the turret of the vehicle that with the bearing of the bottom seat bracket allows the seat to freely rotate relative to the turret; and
an energy attenuation device on a side of the seating assembly that is aligned with the linear guides.

2. The seating assembly of claim 1 wherein the energy attenuation device allows movement to absorb energy in a controlled manner.

3. The seating assembly of claim 1 including gas shock or spring on each side of the seating assembly, wherein the gas shock flips the seat base automatically when the seat base is not occupied.

4. The seating assembly of claim 1 wherein the height adjustment lock includes a cam-action locking detent to secure the seat at different heights.

5. The seating assembly of claim 1 further comprising a belt system with a one-hand release system.

6. The seating assembly of claim 1 wherein the bottom seat bracket has a single bearing attached to the floor of the vehicle.

7. A blast-mitigating, adjustable seating assembly for a vehicle comprising:
a seat with a seat back and a seat base that flips up;
a vertical movement device with linear guides cooperating with roller bearings on each side adjacent to the seat back to provide smooth vertical motion;
a height adjustment lock with a cam-action locking detent to secure the seat at different heights;
a bottom seat bracket with a single bearing at a base of the seating assembly to secure the seating assembly to a floor of the vehicle;
a top portion of the seating assembly mounted onto the vehicle that with the bearing of the bottom seat bracket allows the seat to freely rotate relative to the vehicle; and
an energy attenuation device on a side of the seating assembly that is aligned with the linear guides.
